(19) United States
(12) Patent Application Publication
(10) Pub. No.: US 2015/0037579 A1
(43) Pub. Date: Feb. 5, 2015

(54) HOT MELT ADHESIVE COMPOSITION FOR BONDING PACKS OF CONTAINERS

(71) Applicant: H.B. FULLER COMPANY, St. Paul, MN (US)

(72) Inventors: STEFAN JUERS, Lueneburg (DE); ULRICH HOLTIN, Melbeck (DE); CHRISTIAN BECKER, Lueneburg (DE); VERA AXER, Hamburg (DE)

(21) Appl. No.: 14/448,760

(22) Filed: Jul. 31, 2014

Related U.S. Application Data
(60) Provisional application No. 61/860,428, filed on Jul. 31, 2013.

(51) Int. Cl. C09J 123/14; B32B 37/12; B32B 37/16; C09J 7/02

(52) U.S. Cl. CPC C09J 123/14; C09J 7/0203; B32B 37/1207; B32B 37/1284; B32B 37/16; C09J 2205/30; C09J 2423/10; B32B 2037/1215; B32B 2323/00; B32B 2317/22; B32B 2398/20
USPC 428/355 EN; 524/570; 156/324.4

(57) ABSTRACT

The present invention relates to a hot melt adhesive composition comprising homogeneous linear or substantially linear ethylene/alpha-olefin interpolymers, block copolymers, tackifying resins and waxes, and their use in the bonding of bundles of containers such as bottles or cans into packs.

This application claims benefit of or priority to U.S. provisional application No. 61/860,428 filed on Jul. 31, 2013.

### FIELD OF THE INVENTION

The present invention relates to a hot melt adhesive composition comprising homogeneous linear or substantially linear ethylene/alpha-olefin interpolymers, block copolymers, tackifying resins and waxes, and their use in the bonding of bundles of containers such as bottles or cans into packs.

### BACKGROUND OF THE INVENTION

Hot melt adhesive compositions are typically solid at room temperature. Therefore, said adhesive compositions are heated and are subsequently applied to a substrate in a molten state, which is then placed in contact with one or more further substrates. The hot melt adhesive composition cools and solidifies, thereby forming a bond between the substrates.

Hot melt adhesives using homogeneous ethylene/alpha-olefin interpolymers are known, for example, from U.S. Pat. No. 6,582,829 B1, EP 0 886 656 B1, US 2012/0259050 A1 and U.S. Pat. No. 6,846,876 B1.

U.S. Pat. No. 6,582,829 B1 discloses hot melt adhesive compositions comprising homogeneous linear or substantially linear ethylene/alpha olefin interpolymers, block copolymers and at least one tackifying resin for use as pressure sensitive adhesives in the disposable article manufacture and as construction adhesives for low application temperature uses. The compositions described therein typically use high wax and tackifier contents and have low viscosity at application temperatures to be easily applicable with hot melt applicators and machinery.

US 2012/0259050 A1 describes hot melt adhesive compositions composed of metallocene catalyzed polyethylene polymers, styrenic block copolymers, tackifiers and solid plasticizers. The solid plasticizers are said to improve hot tack, and the adhesives should be applicable for applications such as disposable non-woven hygiene articles, paper converting, flexible packaging, wood working, carton and case sealing and labeling. The hot melt adhesives of US 2012/0259050 A1 typically have low viscosity at temperatures above 177° C. (350 F).

### SUMMARY OF THE INVENTION

For bonding bottles into sixpacks or other pack sizes, there is a need for improved hot melt adhesive compositions having substantially the same cohesive properties in a temperature range of from 5° C. to 45° C. In addition, there is a need for improved hot melt adhesive compositions having sufficiently high viscosity at higher application temperatures (above 190° C.) to allow for a high hot tack and good adhesion/cohesion on bottle materials such as PET, glass and metal, even on wet surfaces. Also, there is a need for adhesives having a sufficiently high viscosity to prevent run-down of liquid adhesive on the bottle's side. Furthermore, there is a need for improved hot melt adhesives that can be applied to a substrate quickly and without stringing. These properties are particularly important for the use of hot melt adhesive compositions in the production of packs of containers such as bottles, wherein several bottles are glued together with a hot melt adhesive to form a bundle, for example a sixpack.

Thus, it is an object of the present invention to provide a hot melt adhesive composition, particularly for bonding bottles to form sixpacks, having substantially the same cohesive and/or adhesive properties in a temperature range of from 5° C. to 45° C.

A further object of the invention is the provision of improved hot melt adhesive compositions that have sufficiently high hot tack and good adhesion/cohesion on bottle materials such as PET, glass and metal, even on cold and/or wet surfaces.

A still further object of the invention is the provision of improved hot melt adhesive compositions that can be applied to a substrate quickly and without stringing.

The present invention is directed to a hot melt adhesive composition comprising:
a) from about 35 to about 60 wt.-% of at least one homogenous linear or substantially linear interpolymer of ethylene and α-olefin;
b) from about 5 to about 25 wt.-% of at least one block copolymer;
c) from about 25 to about 45 wt.-% of at least one tackifing resin; and
d) less than about 10 wt.-% of at least one wax;
   wherein the sum of components a), b) and c) amounts to at least 85 wt.-% of the total adhesive composition, and wherein the composition has a Brookfield viscosity at a temperature of 190° C. in the range from about 7,000 to about 12,000 mPa·s.

In a preferred embodiment, the present invention is further directed to a hot melt adhesive composition, consisting of from about 35 to about 60 weight percent of at least one homogenous linear or substantially linear interpolymer of ethylene and 1-octene; from about 5 to about 25 weight percent of at least one block copolymer; from about 25 to about 45 weight percent of at least one tackifying resin; from about 1 to about 10 weight percent of at least one wax; and at least one antioxidant; wherein the sum of all components amounts to 100 percent, and wherein the composition has a Brookfield viscosity at a temperature of 190° C. in the range from about 7,000 to about 12,000 mPa·s.

In a further preferred embodiment, the present invention is directed to a hot melt adhesive composition, consisting of from about 40 to about 50 weight percent of at least one homogenous linear or substantially linear interpolymer of ethylene and 1-octene; from about 10 to about 15 weight percent of at least one block copolymer; from about 30 to about 40 weight percent of at least one tackifying resin; from about 3 to about 6 weight percent of at least one wax; and at least one antioxidant; wherein the sum of all components amounts to 100 percent, and wherein the composition has a Brookfield viscosity at a temperature of 190° C. in the range from about 7,000 to about 12,000 mPa·s.

Further preferred embodiments of the inventive hot melt adhesive composition are defined by combination of the above described embodiments with the features of the dependent claims provided herein, set out below in detail.

The invention is further directed to the use of a hot melt adhesive composition as defined herein for bonding bundles of containers such as bottles or cans into packs.

The invention is further directed to a container pack comprising a plurality of containers which are bonded to each other with an adhesive composition as described herein.

The hot melt adhesive composition of the present invention exhibits a combination of improved properties, including excellent viscosity and color fastness color stability, particularly at elevated temperatures; high cohesive strength and improved adhesion to difficult-to-bond substrates with low surface tension such as PET (polyethylene terephthalate) and polyolefin substrates such as containers, particularly bottles made of these materials.

Furthermore, the hot melt adhesive of the present invention is particularly suitable for and designed to form, for example, a six pack of PET bottles, glass bottles or cans by directly adhering the bottles together with the non-reactive hot melt adhesive rather than by shrink wrapping them.

The hot melt adhesive composition of the invention has a unique combination of good low temperature (for refrigeration) and high temperature (for shipping) resistance, which is required especially for the bonding of bottle packs. For example, packs or bundles of bottles bonded together with the adhesive of the invention are able to remain bonded when exposed to condensed water on the surface of the bottle.

Furthermore, the adhesives of the invention exhibit well balanced cohesive properties allowing for the bottles being pulled apart by the consumer when beverages are consumed.

### DETAILED DESCRIPTION OF THE INVENTION

In general, hot melt adhesives are thermoplastic compositions that are applied in a molten or flowable form. For many applications, hot melt adhesives are employed to bond two or more substrates while the adhesive is sufficiently molten. In other instances, the adhesive may be applied to a single substrate and cooled. The adhesive is subsequently bonded to a second substrate or surface with heat re-activation. For the purpose of the invention, “hot melt adhesive” refers to all such adhesive compositions.

The following abbreviations and definitions are used in the context of the present invention.

The undefined article “a” or “an” means one or more of the species designated by the term following said article. For example, “a particulate form” encompasses one or more particulate forms.

The term “about” in the context of the present application means a value within 15% (±15%) of the value recited immediately after the term “about,” including any numeric value within this range, the value equal to the upper limit (i.e., +15%) and the value equal to the lower limit (i.e., −15%) of this range. For example, the phrase “about 100” encompasses any numeric value that is between 85 and 115, including 85 and 115 (with the exception of “about 100%”, which always has an upper limit of 100%). A further exception is the phrase “about 0” or “about 0%”, which always has a lower limit of 0 or 0%). In a preferred aspect, “about” means ±10%, even more preferably ±5%, even more preferably ±1% or less than ±1%.

The amount of a specific component, which is included in the hot melt adhesive composition may be defined as the weight per weight percentage as defined by the following ratio: wt.-%=(g of specific component)/(g of composition comprising specific components). For example, when 2.5 g of wax in 100 g of a hot melt adhesive are used, this results in a ratio of 2.5 wt-% (2.5/100) of wax.

For the purpose of the present invention, the term “hot melt” or “hot melt composition” refers to a solvent free product which is substantially solid at room temperature, e.g. at a temperature between about 20° C. and about 25° C. When heated the hot melt becomes tacky and preferably liquid (molten) and can be applied, for example to a substrate to provide an adhesive surface.

The hot melt adhesives of the present invention have a composition specifically designed for the application in gluing containers such as bottles or cans together to form packs that can be commercially used without unwanted breakage of bonds or loosening of containers from the pack. The hot melt adhesives described herein have an unusual and unique combination of properties for the intended use, namely high viscosity at higher application temperatures, good tack at low temperatures, good tack on difficult to bond, low temperature flexibility, and tolerance against wet surfaces. In particular, the hot melt adhesives of the invention are uniquely adapted to their intended use described herein, and show specifically a high cohesion in combination with sufficient flexibility/elasticity at low temperature with only low, or, especially preferred, no plasticiser content.

Interpolymers

The hot melt adhesive composition of the invention comprises at least one homogeneous ethylene/alpha-olefin interpolymer which is an interpolymer of ethylene and at least one C₃-C₁₀ alpha-olefin. The term “interpolymer” is used herein to indicate a copolymer, or a terpolymer, or a higher order polymer. That is, at least one other comonomer is polymerized with ethylene to make the interpolymer.

Homogeneous ethylene/alpha-olefin interpolymers differ from amorphous polyolefins also described as amorphous polyalphaolefins (APAO), with regard to homogeneity, molecular weight distribution (M_{w}/Mₙ), as well as comonomer (alpha-olefin) content. Amorphous polyolefins are homopolymers, copolymers and terpolymers of C₂-C₈ alpha-olefins which are typically polymerized by means of processes which employ Ziegler-Natta catalysts, resulting in a relatively broad molecular weight distribution, typically greater than 4. In contrast, the homogeneous ethylene/alpha-olefin interpolymers useful in the inventive adhesive composition are characterized as having a narrow molecular weight distribution. The homogeneous ethylene/alpha-olefins have a M_{w}/Mₙ of less than 4, preferably less than 3, more preferably from 1.5 to 2.5, even more preferably from 1.8 to 2.2, and most preferably about 2.0. Homogeneous ethylene/alpha-olefins useful for the invention can be produced by use of constrained geometry catalysis (e.g. metallocene catalysis), or alternately by any other catalyst that results in the desired molecular weight distribution. Further, whereas amorphous polyolefins produced from Ziegler-Natta catalysis typically have an alpha-olefin content greater than 50 wt-%, homogeneous ethylene/alpha-olefin interpolymers useful in the present invention are predominantly ethylene, having a greater ethylene content than comonomer content.

It is also noted that substantially linear interpolymers useful in the invention differ from low density polyethylene prepared in a high pressure process. In one regard, whereas low density polyethylene is an ethylene homopolymer having a density from about 0.900 to about 0.935 g/cm³, the homogeneous linear and substantially linear interpolymers useful in the invention typically require the presence of a comonomer to reduce the density.

The homogeneous ethylene/alpha-olefin interpolymer usable in the present invention is a homogeneous linear or substantially linear ethylene/alpha-olefin interpolymer. By the term “homogeneous”, it is meant that any comonomer is randomly distributed within a given interpolymer molecule and substantially all of the interpolymer molecules have the same ethylene/comonomer ratio within that interpolymer. The melting peak of homogeneous linear and substantially linear ethylene polymers, as obtained using differential scanning calorimetry, will broaden as the density decreases and/or as the number average molecular weight decreases. However, unlike heterogeneous polymers, when a homogeneous polymer, prepared in a solution polymerization process, has a melting peak greater than 115° C. (such as is the case of polymers having a density greater than about 0.940 g/cm³), it does not additionally have a distinct lower temperature melting peak.

Substantially linear ethylene interpolymers are homogeneous interpolymers typically having long chain branching. The long chain branches of substantially linear ethylene interpolymers typically have the same comonomer distribution as the interpolymer backbone and can be as long as about the same length as the length of the interpolymer backbone. When a substantially linear ethylene/alpha-olefin interpolymer is employed in the practice of the invention, such interpolymer will be characterized as having an interpolymer backbone substituted with from 0.01 to 3 long chain branches per 1000 carbons. Methods for determining the amount of long chain branching present, both qualitatively and quantitatively, are known in the art.

The homogeneous ethylene/alpha-olefin interpolymer is an interpolymer of ethylene with at least one comonomer selected from the group consisting of C₃-C₁₀ alpha-olefins. Exemplary C₃-C₁₀ alpha-olefins include propylene, isobutylene, 1-butene, 1-hexene, 4-methyl-1-pentene, 1-heptene, and 1-octene. Preferred alpha-olefins include 1-butene, 1-hexene, 4-methyl-1-pentene, 1-heptene, and 1-octene, more preferably 1-hexene and 1-octene, particularly 1-octene.

The molecular weight of the homogeneous ethylene/alpha-olefin interpolymer will be selected on the basis of the desired performance attributes of the adhesive formulation. Typically, the homogeneous ethylene/alpha-olefin interpolymer will have a number average molecular weight of at least 800 grams/mole, preferably at least 1,300 and no more than 100,000 g/mole. Ultra low molecular weight homogeneous ethylene/alpha-olefin interpolymers are considered to have a number average molecular weight of less than about 12,000 g/mole, typically from about 8,000 to about 12,000 g/mole.

In the composition of the present invention it is particularly preferred to use at least one homogeneous linear or substantially linear interpolymer of ethylene and 1-octene, preferably having a number average molecular weight from about 9,000 to about 12,000 g/mole.

The hot melt adhesive compositions of the invention may include homogeneous ethylene/alpha-olefin interpolymers typically having a melt index or melt flow index of greater than about 0.1 g/10 min, more typically greater than about 5 g/10 min, preferably greater than about 30 g/l 0 min, more preferably greater than about 50 g/10 min, even more preferably greater than about 100 g/10 min, even more preferably greater than about 200 g/10 min and preferably the melt index ranges from about 300 g/10 min to about 1500 g/10 min and most preferably the melt index ranges from about 500 g/10 min to about 1000 g/10 min Further, in some instances the melt index can range as high as 4000 g/10 min Melt (flow) indices as described herein are determined by the procedure of ASTM-D-1238, 190° C., 2.16 kg load, if not explicitly stated otherwise.

The melt index inversely relates to the molten viscosity. The viscosity at 190° C. of the hot melt adhesives of the invention ranges from about 7,000 mPa·s (cP) to about 12,000 mPa·s (cP), preferably from about 8,000 mPa·s (cP) to about 11,000 mPa·s (cP), and more preferably from about 8,500 mPa·s (cP) to about 10,000 mPa·s (cP). Viscosities as described herein are determined by a standard Brookfield viscometer, spindle 27, at the temperature given, if not explicitly stated otherwise. The viscosity at 350° F. (177° C.) of the hot melt adhesives of the invention ranges from about 10,000 mPa·s (cP) to about 20,000 mPa·s (cP), preferably from about 12,000 mPa·s (cP) to about 16,000 mPa·s (cP), and more preferably from about 13,000 mPa·s (cP) to about 14,000 mPa·s (cP).

The density of the homogeneous ethylene/alpha-olefin interpolymer will be selected on the basis of the desired performance attributes of the adhesive formulation. Typically however, the homogeneous ethylene/alpha-olefin interpolymer will have a density of at least about 0.850 g/cm³, preferably at least about 0.860 g/cm³, and more preferably at least about about 0.870 g/cm³. For the majority of the preferred compositions for targeted adhesive applications, the homogeneous ethylene/alpha-olefin interpolymer will have a density of no more than about 0.965 g/cm³, preferably no more than about 0.900 g/cm³, more preferably no more than about 0.890 g/cm³, and even more preferably no more than about 0.885 g/cm³, and most preferably no more than about 0.880 g/cm³. Specifically preferred, the at least one homogenous linear or substantially linear interpolymer of ethylene and 1-octene has a density of from about 0.860 to about 0.890 g/cm³.

The hot melt adhesive composition of the present invention typically includes rather high amounts of the at least one homogeneous ethylene/alpha-olefin interpolymer. The homogeneous ethylene/alpha-olefin interpolymer will be present in the adhesive composition of the invention in an amount of about 35 wt-% and up to about 60 wt-%, and preferably about 40 wt-% to about 50 wt-%, most preferably about 42 to about 48 wt-%.

The adhesive composition comprises either a single homogeneous ethylene/alpha-olefin interpolymer or a blend of two or more interpolymers. In instances when a single homogeneous ethylene/alpha-olefin interpolymer is employed, the interpolymer will preferably have a density ranging from about 0.860 g/cm³ to 0.890 g/cm³ and a melt index from about 500 g/10 min to about 1000 g/10 min. In the case of homogeneous ethylene/alpha-olefin interpolymer blends, the density of the interpolymer blend will preferably possess the targeted density and melt index. However, the individual interpolymers comprised in the blend may have a density and/or melt index outside of the specified range.

When employing two or more homogeneous ethylene/alpha-olefin interpolymers, the first and second interpolymer will differ from each other with respect to the type of comonomer and/or the molecular weight or melt index, and/or the density, and/or the molecular weight distribution. Accordingly, the first and second interpolymer may differ in number average molecular weight by at least 5000, preferably at least 10,000, and more preferably at least 20,000. In addition or in the alternative, the first and second interpolymers may differ in density by at least 0.005 g/cm³, preferably by at least 0.01 g/cm³.

In preferred embodiments, the at least one homogenous linear or substantially linear interpolymer of ethylene and alpha-olefin comprises a substantially linear interpolymer of ethylene and 1-octene which is grafted with a dicarboxylic acid anhydride, preferably a maleic anhydride grafted ethylene 1-octene interpolymer.

When employing two or more ethylene/alpha-olefin interpolymers, the hot melt adhesive composition includes a blend of at least one homogenous linear or substantially linear interpolymer of ethylene and alpha-olefin and a substantially linear interpolymer of ethylene and 1-octene which is grafted with a dicarboxylic acid anhydride, preferably a maleic anhydride grafted ethylene/l-octene interpolymer. The polymers may be used in a weight ratio of 3:1 to 1:3, preferably 2:1 to 1:2, and most preferably of 1:1. Particularly preferred for use in the invention as the at least one homogenous linear or substantially linear interpolymer of ethylene and alpha-olefin is a blend of a substantially linear interpolymer of ethylene and 1-octene and a maleic anhydride grafted ethylene/l-octene interpolymer in a weight ratio of 1:1.

Homogeneous linear ethylene/alpha-olefin interpolymers are currently available from Mitsui Petrochemical Company under the trade name “Tafmer” and from Exxon Chemical Company under the trade name “Exact”. Substantially linear ethylene/alpha-olefin interpolymers are available from the Dow Chemical Company as Affinity® polyolefin plastomers and elastomers, and Engage® polyolefin elastomers. Specifically preferred for use in the present invention are for example Affinity® GA 1875, GA 1900, GA 1950 and GA 1000R. Affinity® GA 1000R is a preferred maleic anhydride grafted ethylene/l-octene interpolymer.

Block Copolymer

Suitable block copolymers for use in the present invention include those having at least one A block that includes a vinyl aromatic compound and at least one B block that includes an elastomeric conjugated diene, including hydrogenated or unhydrogenated conjugated dienes, and combinations thereof. The A blocks and the B blocks may bind to one another in any manner of binding such that the resulting copolymer is random, block, straight-chained, branched, radial, or a combination thereof. The block copolymer can exhibit any form including, e.g., linear A-B block, linear A-B-A block, linear A-(B-A)ₙ-B multi-block, and radial (A-B)ₙ—Y block where Y is a multivalent compound and n is an integer of at least 3, tetrablock copolymer, e.g., A-B-A-B, and pentablock copolymers having a structure of A-B-A-B-A. The adhesive composition can include blends of at least two different block copolymers.

Useful vinyl aromatic compounds include, e.g., styrene, alpha-methylstyrene, o-methylstyrene, m-methylstyrene, p-methylstyrene, p-tert-butylstyrene, 2,4-dimethylstyrene, 2,4,6-trimethylstyrene, diphenylethylenes including stilbene, vinyl naphthalene, vinylanthracene, vinyltoluene (a mixture of meta- and para-isomers of methylstyrene), vinylxylene, and combinations thereof. Suitable conjugated dienes include, e.g., butadiene (e.g., polybutadiene), isoprene (e.g., polyisoprene), 2,3-dimethyl-1,3-butadiene, 1,3-pentadiene, 1,3-hexadiene, and combinations thereof, and hydrogenated versions thereof including, e.g., ethylene, propylene, butylene and combinations thereof.

Useful block copolymers include polyvinyl aromatic in an amount between about 0 wt % and about 50 wt %, between about 5 wt % and about 50 wt %, between about 15 wt % and about 35 wt %, or even between about 20 wt % and about 30 wt %. Suitable block copolymers have a melt flow index between about 3 g/10 min and about 50 g/10 min, or between about 5 g/10 min and about 20 g/10 min, as determined by ASTM-D 1238.

The A block can also include a small amount (e.g. no greater than 10 wt % based on the weight of the A block) of a structural unit derived from unsaturated monomers other than the vinyl aromatic compounds including, e.g., 1-butene, pentene, hexene, butadiene, isoprene, methyl vinyl ether, methyl methacrylate, vinyl acetate and combinations thereof. The B block can also include a small amount (e.g., no greater than 10 wt % based on the amount of the B block) of a structural unit derived from unsaturated monomers other than the conjugated diene including, e.g., 1-butene, 1-pentene, 1-hexene, methyl vinyl ether, styrene, methyl methacrylate, and combinations thereof.

Useful block copolymers include or may be based on, e.g., random styrene-butadiene polymers, styrene-butadiene block copolymers, multiarmed and repeating styrene-butadiene copolymers, styrene-butadiene-styrene block copolymers, styrene-isoprene block copolymers, styrene-isoprene-styrene block copolymers, styrene-multiarmed styrene-isoprene (SI)ₓ block copolymers, styrene-ethylene-butylene-styrene block copolymers (SEBS), styrene-isobutylene-styrene block copolymers (SIS), styrene-ethylene-ethylene-propylene-styrene block copolymers, styrene-ethylene-propylene-styrene block copolymers (SEPS) and combinations thereof.

Block copolymers for use in the invention are commercially available under the KRATON® D and G series of trade designations from Shell Chemical Company (Houston, Tex.) including, e.g., KRATON D 1163 and 1117 and KRATON G 1652, 1657 and 1726, EUROPRENE® Sol T trade designation from EniChem (Houston, Tex.), SEPTON® trade designation from Septon Company of America (Pasadena, Tex.) including SEPTON® S 1001 styrene-ethylene-propylene-styrene block copolymer, and SEPTON® 4030, 4033, 4044, 4055 and 4077 block copolymers, and VECTOR® series of trade designations from Dexco (Houston, Tex.) including VECTOR® 4211 styrene-isoprene-styrene block copolymer. Preferred examples of styrene-isoprene (SI) or styrene-isoprene-styrene (SIS) include KRATON D1117 and KRATON D11161 NS, available from Kraton Polymers, US, VECTOR 4114A and VECTOR 4411 A from Dexco Polymers, USA. Also suitable as the block copolymer component in the present invention are based thermoplastic elastomers such as from the Globalprene series, available from LCY Chemical Corp. Examples are Globalprene SEBS 9550, 9551, 9552, 9553, or 9554.

Preferably, the at least one block copolymer in the adhesive composition of the present invention is selected from at least one of a diblock styrenic block copolymer, or a triblock styrenic block copolymer, preferably styrene-ethylene/butylene-styrene (SEBS) or styrene-ethyleneipropylene-styrene (SEPS). In embodiments, the at least one block copolymer is selected from a group consisting of styrene-ethylene/butylene-styrene (SEBS) and styrene-ethyleneipropylene-styrene (SEPS). Particularly preferred are such triblock copolymers having a low styrenic content, such as below 20 wt.-%, preferably 10 to 15 wt.-%.

The at least one block copolymer is present in the adhesive composition in an amount between about 5 wt.-% and about 25 wt.-%, between about 10 wt.-% and about 20 wt.-%, between about 10 wt.-% and about 15 wt.-%, or even between about 12 wt.-% and about 14 wt.-%.

In a preferred embodiment the block copolymers have a melt flow index between about 0.1 g/10 min and about 4,000 g/10 min, preferably between about 10 g/10 min and about 60 g/10 min and most preferably between about 20 g/10 min and about 40 g/10 min, most preferred between about 20 g/10 min and about 25 g/10 min. A particularly preferred polymer such as styrene-ethylene/butylene-styrene (SEBS) has a density between about 0.8 g/cm³ and about 1.0 g/cm³, preferably between about 0.88 g/cm³ and about 0.94 g/cm³.

Tackifiers

In addition to the homogeneous ethylene/alpha-olefin interpolymer and block copolymer, the adhesive compositions of the present invention comprise one or more tackifiers. As used herein, the term “tackifier” or “tackifying resin” means any of the compositions described below which are useful to impart tack to the hot melt adhesive composition. ASTM D-1878-61T defines tack as “the property of a material which enables it to form a bond of measurable strength immediately on contact with another surface”.

The adhesive of the invention comprises from 25 wt-% to about 45 wt-% of a tackifying resin, preferably from 30 wt-% to about 40 wt-% tackifier, and most preferably from about 32 wt-% to about 38 wt-% tackifier. The tackifying resin can be at least partially hydrogenated in order to improve stability for bulk handling. Useful tackifying agents have Ring and Ball softening point of less than about 140° C., less than about 130° C., less than about 100° C., or even less than about 90° C.

The tackifying resin can be liquid or solid at room temperature. Suitable classes of tackifying resins include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof. Examples of useful natural and modified rosins include gum rosin, wood rosin, tall oil rosin, distilled rosin, hydrogenated rosin, dimerized rosin and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, and phenolic-modified pentaerythritol esters of rosin. Specifically preferred tackifying resins include cycloaliphatic hydrocarbon compounds, preferably hydrogenated dicyclopentadiene hydrocarbon resins.

Examples of useful polyterpene tackifying resins include polyterpene resins having a softening point, as determined by DIN EN 1427 (Ring and Ball) of from about 10° C. to about 180° C., hydrogenated polyterpene resins, and copolymers and terpolymers of natural terpenes (e.g. styrene-terpene, alpha-methyl styrene-terpene and vinyl toluene-terpene). Examples of useful aliphatic and cycloaliphatic petroleum hydrocarbon resins include aliphatic and cycloaliphatic petroleum hydrocarbon resins having Ring and Ball softening points of from about 10° C. to about 140° C. (e.g., branched and unbranched C5 resins, C9 resins, and C10 resins) and the hydrogenated derivatives thereof.

Useful tackifying resins are commercially available under a variety of trade designations including, e.g., the ESCOREZ series of trade designations from Exxon Mobil Chemical Company (Houston, Tex.) including ESCOREZ 1310 LC, ESCOREZ 5400, ESCOREZ 5415, ESCOREZ 5600, ESCOREZ 5615, and ESCOREZ 5690, the EASTOTAC series of trade designations from Eastman Chemical (Kingsport, Tenn.) including EASTOTAC H-100R, EASTOTAC H-100L, and EASTOTAC H130W, the WINGTACK series of trade designations from Cray Valley HSC (Exton, Pa.) including WINGTACK 86, WINGTACK EXTRA, and WINGTACK 95, the PICCOTAC and KRISTALEX series of trade designations from Eastman Chemical Company (Kingsport, Tenn.) including, e.g., PICCOTAC 8095 and KRISTALEX 3100, ARKON M-100 of trade designations from Arakawa Europe GmbH, Germany, SUKOREZ SU-90, SUKOREZ SU-100, or SUKOREZ SU-120 of trade designations from Kolon Industries Inc., Korea, and SYLVARES 7115 and SYLVARES SA 140 of trade designatons from Arizona Chemical, USA.

Preferably, the hot melt adhesive composition of the present invention comprises at least one tackifying resin with a Ring & Ball softening point of about 100° C., and/or at least one tackifying resin with a Ring & Ball softening point of about 90° C., preferably at least one thereof, most preferably both being selected from cycloaliphatic hydrocarbon compounds, preferably hydrogenated dicyclopentadiene hydrocarbon resins.

If blends or mixtures of such tackifiers are used, it is preferred that at least one tackifying resin is included that has a Ring & Ball softening point of about 90° C. or less. Blends of at least two tackifying resins may include at least one tackifying resin having Ring & Ball softening point of about 90° C. or less, and at least one tackifying resin having a Ring & Ball softening point of about 100° C. or more, in a weight ratio from 1:3 to 3:1, preferably a weight ratio from 1:2 to 2:1, most preferably 1:1.

It has been found that a well-balanced cohesion performance of the adhesive at low temperatures from 5° C. to room temperature and above, e.g. 45° C. can be achieved with the use of tackifying resins having a Ring & Ball softening point of 90° C. or less in mixture with a resin having a higher Ring & Ball softening point. For example, using at least one preferably cycloaliphatic hydrocarbon based tackifying resin, having a Ring & Ball softening point of 90° C. or less, lowers the glass transition temperature of the adhesive and improves the cohesion performance and flexibility of the adhesive, specifically at low temperatures from about 5° C. to 15° C. and up to room temperature. In addition, the hot melt composition of the present invention preferably includes a tackifying resin with a Ring & Ball softening point of at least 100° C., which contributes to improved flexibility and imparts sufficient heat resistance to the adhesive composition.

For bonding e.g. six packs of bottles or cans, an excellent performance has been achieved with a preferred hot melt composition including a blend of two different tackifying resins, wherein one tackifying resin has softening point of 90° C. or less, and the other tackifying resin has a softening point of 100° C. or more, in a weight ratio from 1:2 to 2:1, most preferably 1:1. Specifically preferred are tackifying resins both being selected from hydrogenated dicyclopentadiene hydrocarbon resins.

Waxes

Waxes are commonly used to modify the viscosity and reduce tack. Waxes are included in the adhesive compositions of the present invention in low amounts, at concentrations less than 10 wt-%, preferably at concentrations ranging from about 1 wt-% to about 10 wt-%, more preferably in amounts ranging from about 2 wt-% to about 8 wt-%, and most preferably from about 3 wt-% to about 6 wt-%.

Waxes useful in the adhesives of the present invention include paraffin waxes, microcrystalline waxes, hydrogenated microwaxes, Fischer-Tropsch waxes, oxidized Fischer-Tropsch waxes, polyethylene and by-products of polyethylene wherein M_{w} is less than 3000, and functionalized waxes such as hydroxy stearamide and fatty amide waxes. The terminology “synthetic high melting point” (HMP) waxes includes high density low molecular weight polyethylene waxes, by-product polyethylene waxes, and Fischer-Tropsch waxes. In embodiments, the at least one wax is selected from the group consisting of paraffin waxes, microcrystalline waxes, Fischer-Tropsch waxes, synthetic high melting point waxes (HMP) and hydrogenated microwaxes

Also suitable are ultra-low molecular weight ethylene/alpha-olefin interpolymers prepared using a constrained geometry (e.g. metallocene) catalyst, which may be referred to as homogeneous waxes. Such homogeneous waxes, as well as processes for preparing such homogeneous waxes, are set forth in the Examples below. Homogeneous waxes, in contrast to paraffinic waxes and crystalline ethylene homopolymer or interpolymer waxes, will have a Mw/Mn from 1.5 to 2.5, preferably from 1.8 to 2.2.

Homogeneous waxes will be either ethylene homopolymers or interpolymers of ethylene and a C₃-C₁₀ alpha-olefin. The homogeneous wax will have a number average molecular weight less than 6000, preferably less than 5000. Such homogeneous waxes will typically have a number average molecular weight of at least 800, preferably at least 1300.

Additives

The hot melt adhesive composition of the present invention may include additives commonly used in hot melt adhesives. For example, components can be added to modify the tack, color, odor, etc., of a hot melt adhesive. Additives such as antioxidants, for example, hindered phenolics (for example, Irganox® 1010, Irganox® 1076, all BASF, or Vulkanox BHT, Lanxess), phosphites (for example, Irgafos® 168, BASF), Evernox® 10, Irganox® PS800 from BASF, or any mixtures thereof, antiblock additives, pigments, and fillers, can also be included in the formulations. It is generally preferred that the additives should be relatively inert and have negligible effects upon the properties contributed by the homogeneous linear or substantially linear interpolymer, block copolymer, tackifying agent, and wax.

Additives may be generally used in small amounts, typically less than 10 wt.-%, preferably less than or up to 5 wt.-%, or even up to 3 wt.-%. One or more antioxidants are typically present in an amount of less than 2 wt.-%, preferably less than 1 wt.-%. Combinations of at least two different antioxidants are preferred, particularly preferred three different antioxidants in combination, to impart color stability. Antioxidants are specifically preferred ingredients to ensure thermal stability of the adhesives at high application temperatures of at least about 190° C., to avoid color changes such as yellowing, avoidance of which is typically desired for aesthetic reasons.

Since the adhesive compositions of the present invention are, for example, applied to containers including beverages, the use of oil as plasticizer should be preferably avoided due to possible migration issues, i.e. the unwanted migration of adhesive contaminants into the container material and possibly also into its contents.

Therefore, preferably, all embodiments of the hot melt adhesive composition of the present invention are substantially free of plasticizers, particularly free of oils.

Furthermore, it has been found that the use of ethylene/α-olefin interpolymers the glass transition temperature and degree of crystallinity are sufficiently lowered. It is believed that these ethylene/α-olefin interpolymers are “internally plasticized” by their relatively long α-olefinioctene side chains, so that the addition of separate plasticizers is not required. Also, the addition of, e.g. solid plasticizers would interfere with the required high viscosity at application temperature, to avoid liquid adhesive running down the container. Therefore, also solid plasticizers as used in prior art adhesives are preferably avoided.

Thus, preferably, all embodiments of the hot melt adhesive composition of the present invention are also substantially free of solid plasticizers.

Furthermore, if desired, performance additives may be used in small amounts, typically less than 15 wt.-%, preferably less than 10 wt.-%, more preferably less than or up to 5 wt.-%.

Such performance additives may serve to improve tack on specific substrates, low temperature adhesion and flexibility, high temperature tolerance, etc., and can be selected from metallocene polyolefines such as polypropylene, for example Licocene PP MA 6252 GR, from Clariant, which is a maleic anhydride grafted metallocene polypropylene; or olefin block copolymer such as Infuse 9817, available from DowChemicals; or copolymers from ethylene and acrylic acid, e.g. A-C 5120 from Honeywell; ethylene/ethyl acrylate/maleic acid anhydride terpolymer, e.g. Lotader 8200 from Arkema; copolymers from ethylene and maleic anhydride such as A-C 573 from Honeywell; or high density oxidized polyethylene e.g. A-C 392 from Honeywell.

Preferred Compositions

All weight percentages refer to total weight of compositions.

A preferred hot melt adhesive composition of the invention comprises:

a) from about 40 to about 50 weight percent of at least one homogenous linear or substantially linear interpolymer of ethylene and α-olefin;

b) from about 5 to about 25 weight percent of at least one block copolymer;

c) from about 25 to about 45 weight percent of at least one tackifying resin; and

d) less than 10% weight percent of at least one wax; wherein the sum of components a), b) and c) amounts to at least 85, preferably at least 90, and more preferably at least 95 weight percent of the total adhesive composition, and wherein the composition has a Brookfield viscosity at a temperature of 190° C. in the range from about 7,000 to about 12,000 mPa·s.

A further preferred hot melt adhesive composition of the invention comprises:

a) from about 40 to about 50 weight percent of at least one homogenous linear or substantially linear interpolymer of ethylene and α-olefin;

b) from about 10 to about 15 weight percent of at least one block copolymer;

c) from about 25 to about 45 weight percent of at least one tackifying resin; and

d) less than 10% weight percent of at least one wax; wherein the sum of components a), b) and c) amounts to at least 85, preferably at least 90, and more preferably at least 95 weight percent of the total adhesive composition, and wherein the composition has a Brookfield viscosity at a temperature of 190° C. in the range from about 7,000 to about 12,000 mPa·s.

A further preferred hot melt adhesive composition of the invention comprises:

a) from about 40 to about 50 weight percent of at least one homogenous linear or substantially linear interpolymer of ethylene and α-olefin:

b) from about 10 to about 15 weight percent of at least one block copolymer;

c) from about 30 to about 40 weight percent of at least one tackifying resin; and

d) less than 10% weight percent of at least one wax; wherein the sum of components a), b) and c) amounts to at least 85, preferably at least 90, and more preferably at least 95 weight percent of the total adhesive composition, and wherein the composition has a Brookfield viscosity at a temperature of 190° C. in the range from about 7,000 to about 12,000 mPa·s.

A further preferred hot melt adhesive composition of the invention comprises:

a) from about 40 to about 50 weight percent of at least one homogenous linear or substantially linear interpolymer of ethylene and α-olefin;

b) from about 10 to about 15 weight percent of at least one block copolymer;

c) from about 30 to about 40 weight percent of at least one tackifying resin; and

d) from about 1 to 10%, preferably from about 3-6 weight percent of at least one wax; wherein the sum of components a), b) and c) amounts to at least 85, preferably at least 90, and more preferably at least 95 weight percent of the total adhesive composition, and wherein the composition has a Brookfield viscosity at a temperature of 190° C. in the range from about 7,000 to about 12,000 mPa·s.

A further preferred hot melt adhesive composition of the invention comprises:

a) from about 35 to about 60 weight percent of at least one homogenous linear or substantially linear interpolymer of ethylene and α-olefin;

b) from about 10 to about 15 weight percent of at least one block copolymer;

c) from about 30 to about 40 weight percent of at least one tackifying resin; and

d) less than 10% weight percent of at least one wax; wherein the sum of components a), b) and c) amounts to at least 85, preferably at least 90, and more preferably at least 95 weight percent of the total adhesive composition, and wherein the composition has a Brookfield viscosity at a temperature of 190° C. in the range from about 7,000 to about 12,000 mPa·s.

A further preferred hot melt adhesive composition of the invention comprises:

a) from about 35 to about 60 weight percent of at least one homogenous linear or substantially linear interpolymer of ethylene and α-olefin;

b) from about 10 to about 15 weight percent of at least one block copolymer;

c) from about 30 to about 40 weight percent of at least one tackifying resin; and

d) from about 1 to 10%, preferably from about 3-6 weight percent of at least one wax; wherein the sum of components a), b) and c) amounts to at least 85, preferably at least 90, and more preferably at least 95 weight percent of the total adhesive composition, and wherein the composition has a Brookfield viscosity at a temperature of 190° C. in the range from about 7,000 to about 12,000 mPa·s.

Uses

The hot melt adhesive compositions of the present invention are specifically adapted for bonding substrates such as PET, polyolefines, glass or metal, from which bottles or cans are typically made of.

Therefore, the hot melt adhesive compositions of the present invention are specifically designed and adapted for bonding bundles of containers such as bottles or cans into packs, preferably six-packs. Methods for producing such packs or bundles with the use of adhesives are described for example in international patent applications WO 2013/004337 A1, WO 2013/004339 A1, WO 2013/004340 A1, and WO 2013/004341 A1, all incorporated herein by reference. In such methods, the hot melt adhesive composition of the present invention can be applied directly onto the containers or bottles, on backing sheets between two groups of containers, or both, and allows separating the containers from groups in a non-destructive manner, for example when bottles or tins are pulled apart by the consumer when beverages are consumed.

For example, the use of the hot melt adhesive composition for glueing two bottles to each other a typical procedure involves that the molten adhesive having a temperature of about 180° C. to about 200° C. is rapidly shot with a conventional applicator onto at least one bottle, e.g. onto opposing sides on two standing bottles (one shot takes approximately 50-100 ms), e.g., at the bottom below the label and one on top in a spot where the two bottles touch each other; after about 2 seconds the bottles are combined and pressed together for about a few seconds, such as 5 seconds.

The particular application pattern may be varied as desired. For example, leaving out one or more adhesive spots for better bottle release from the pack can be envisaged, or more adhesive spots for large and heavy bottles.

Typically, the amount of adhesive used per shot varies from about 20 to about 150 mg/shot, usually at about 80 mg/shot. Since such a process is dynamic, times and amounts may vary depending on the size and material of the containers such as bottles or cans and depending on the required ease of separation of the bottles upon use by the customer.

Six packs or other desired pack sizes may be built up similarly, e.g. by gluing together pairs of bonded bottles, or by bonding bottles on backing sheets between two groups of bottles or containers, as described in the above mentioned international patent applications.

The adhesives of the invention have good low temperature (for refrigeration) and high temperature (for shipping) resistance and are able to remain bonded when exposed to condensed water on the surface of the bottle. Also, the adhesive compositions of the invention are flexible enough to allow bottle expansion during warming up when carbonized water or soft drinks are filled and glued together at low temperature such as 3° C. and bottle expansion occurs when the bottle warms up to room temperature. For example, bottle expansion of low temperature filled PET bottles can result in an extension in the range of 1-5 mm and the adhesive of the invention allows this kind of force and keeps the bond closed.

By directly bonding bottles, the adhesives of the invention contribute in avoiding waste by no longer requiring a shrink wrap with LDPE films of the bottle packs. This saves considerable amounts of energy since, for example, shrink wrapping involves six-packs being moved through a heating tunnel which uses large amounts of energy. Furthermore, the new packing process with the inventive adhesives provides smaller packing line footprint and increased packing line speeds. Also, the optical appearance of sixpacks is improved, since undesirable creases in the shrink wrap are avoided. This is highly desirable, because beverage filling companies are especially serious about this. Generally, the present invention advantageously helps to avoid any secondary packaging of container packs, such as carton or cardboard cases or sheaths, plastic rings or sheaths, etc.

### Examples

In the context of the present invention, unless indicated otherwise, the melt flow index or simply melt index (MI) is determined in accordance with ASTM D 1238 at a standard temperature of 190° C. and at 2.16 kg load.

The viscosity is determined similar to method ASTM D-3236 as follows. The viscosity of a sample is determined using a Brookfield Laboratories DVH, DV-II, or DV-III Viscometer. The spindle used is a SC-27 hot melt spindle suitable for measuring viscosities in a range between about 100 mPa·s and about 4,000,000 mPa·s. The sample is placed in a pre-warmed measuring cell, which in turn is inserted into the heating element/container and is locked into place. The sample is heated until it is melted with additional sample being added until the melted sample is about 5 mm higher than the cylinder of the measuring spindle. The viscometer apparatus is lowered and the spindle is submerged into the sample. The viscometer is turned on and set to a shear rate that leads to a torque reading in the range of from 30% to 60%. Readings are taken every minute for about 15 minutes or until the values stabilize. The final reading can be obtained after 30 min and is recorded in mPa·s.

The molecular weight of all materials mentioned in this description, if not expressly stated otherwise, is determined by the method ASTM D 4001-93/2006.

The softening point is determined according to DIN EN 1427 (Ring and Ball) with the Ring and Ball instrument MC753 as summarized as follows. Two shouldered rings are heated to melt temperature and are placed onto a silicon-papered glass-plate and the melted substance is poured into the rings. After cooling, the excess materials were cut off and the samples were placed into the sample holder of the apparatus and the ball-centering guide with the balls is placed above the samples. A 600 ml NF beaker is filled with 500 ml glycerol and is placed on the heating plate of the MC 753 apparatus. The frame, which is ready for measurement with the shouldered rings, is placed into the beaker in such a way that it is centered on the pins. The temperature sensor is adjusted in the therefore designed opening in the frame and the MC 753 apparatus is activated by choosing the measuring point (keyboard 1-10, basic unit). After a certain pre-heating time, the program automatically runs with a heating rate of 5° C. per minute until the balls fall. The measurement is completed when both balls have fallen down and two temperatures are shown on the display.

Polymer density is determined according to method ASTM D 1505.

Materials:

The following materials were used in the below examples, and these materials are specifically preferred in the embodiments of the invention (with the exception of plasticizers):

Ethylene/α-olefin interpolymers

Affinity® GA 1875, Dow, MI 1250 g/10 min

Affinity® GA 1900, Dow, MI 1000 g/10 min

Affinity® GA 1950, Dow, MI 500 g/10 min

Affinity® GA 1000R, Dow, MI 660 g/10 min, maleic anhydride grafted

Affinity® EG 8200G, Dow, MI 5 g/10 min

Engage 8200, Dow, MI 5 g/10 min

Block Copolymers:

Kraton 1652, Kraton polymers, SEBS,

Kraton G 1657, Kraton polymers, SEBS,

Kraton 1726, Kraton polymers, SEBS,

Tackifier:

Eastotack H100 Eastman, hydr. hydrocarbon resin, softening point 100° C.

SUKOREZ SU-1 20, Kolon industries, hydr. hydrocarbon resin, softening point 120° C.

SUKOREZ SU-90 Kolon industries, hydr. hydrocarbon resin, softening point 90° C.

Escorez 5400, ExxonMobil, cycloaliphatic hydrocarbon resin, soft. point 100° C.

Escorez 5600, ExxonMobil, 8-11% aromatic content, softening point 100° C.

Waxes

AC-8, Honeywell, PE wax

Microcrystalline wax HMP, Shell,

Antioxidants:

IRGANOX PS 800, Ciba/BASF, dilaurylthiodipropionate

Evernox 10, Everspring Chemical Co., sterically hindered phenolic antioxidant

IRGANOX 1010, Ciba/BASF

Irgafos 168, BASF, tris(2,4-di-tert-butylphenyl)phosphite

Vulkanox BHT, Lanxess, 3,5-Di-tert-butyl-4-hydroxytoluol

Other Polyolefins:

Licocene PP MA 6252 GR, Clariant, PP maleic anhydride grafted

Infuse 9817, Dow, olefin block copolymer (OBC), MI 15

Vestoplast 750, Degussa/Evonik, APAO

Vestoplast 708, Degussa/Evonik, APAO

PIB 10, Kemat, BE, Polybutene 10 (MW 950)

Plasticizers:

Catenex Oil 941, Shell

Catenex T 145 S, Shell, 100 cSt @40° C.

Primol 542, Exxon Mobil

Paraffinic oil

Embodiment examples 1 to 8 were produced with the compositions shown in Tables 1 and 2.

TABLE 1

| Material | Example 1 | Example 2 | Example 3 |
|---|---|---|---|
| Affinity G 1950 | 46.4 | 46.4 | 46.4 |
| SEBS block | 10 | 13 | 13 |
| copolymer | | | |
| SUKOREZ SU-120 | 11 | | |
| SUKOREZ SU-90 | | | 17.75 |
| Escorez 5400 | 24.5 | 35.5 | 17.75 |
| Wax | 4.5 | 4.5 | 4.5 |
| Antioxidants | 0.6 | 0.6 | 0.6 |
| Catenex Oil 941 | 3 | | |
| Total amount | 100 | 100 | 100 |

TABLE 2

| Material | Example 4 | Example 5 | Example 6 | Example 7 |
|---|---|---|---|---|
| Affinity GA | | 46.4 | 23.2 | 44.4 |
| 1000R | | | | |
| Affinity G 1950 | 41.4 | | 23.2 | |
| Licocene PP | 5 | | | |
| MA 6252 GR | | | | |
| Engage 8200 | | | | 2 |
| SEBS block | 13 | 13 | 13 | 13 |
| copolymer | | | | |
| SUKOREZ SU-90 | | | | 17.75 |
| Escorez 5400 | 35.5 | | | 17.75 |
| Escorez 5600 | | 35.5 | 35.5 | |
| Wax | 4.5 | 4.5 | 4.5 | 4.5 |
| Antioxidants | 0.6 | 0.6 | 0.6 | 0.6 |
| Total amount | 100 | 100 | 100 | 100 |

Examples 1 to 6 use a standard ethylene/α-olefin interpolymer, wherein Example 4 partly replaces the ethylene/α-olefin interpolymer with a grafted polypropylene, to increase substrate adhesion on PET. Example 6 replaces half of the ethylene/α-olefin interpolymer with a maleic anhydride grafted ethylene/α-olefin interpolymer, and Example 7 almost all the interpolymer is grafted ethylene/α-olefin interpolymer While all Examples 1 to 7 use a 100° C. tackifying resin, Example 1 adds a second tackifier having a higher softening point, whereas Examples 3 and 7 use a second tackifier having a lower softening point of only 90° C., for better cold adhesion by lowering the glass transition temperature. Example 1 uses a plasticizer oil to compensate for the higher softening point of the second tackifier. Examples 5 and 6 use a tackifying resin having aromatic contents. The sum of ethylene/α-olefin interpolymer, Block copolymer and tackifying resin is at least about 90 wt.-% of the total composition for all embodiment examples.

The adhesives according to the present invention were compared with the adhesive compositions provided in Table 3, with regard to their suitability to bond six-packs of commercial 1 liter PET-bottles.

TABLE 3
Comparative examples

| | Comparative | Comparative | Comparative |
|---|---|---|---|
| Material | Example 8 | Example 9 | Example 10 |
| Affinity G 1950 | 43.4 | 34 | |
| Vestoplast 750 | | | 24 |
| Vestoplast 708 | | | 34 |
| PIB | | | 5 |
| SEBS block | 16 | 16 | |
| coploymer | | | |
| Eastotack H100 | | | 30 |
| SUKOREZ SU-90 | | 22.45 | |
| Escorez 5400 | 35.5 | 22.45 | |
| (100° C.) | | | |
| Wax (PE, | 4.5 | 4.5 | 2 |
| microwax HMP) | | | |
| Antioxidants | 0.6 | 0.6 | 0.3 |
| Paraffinic oil | | | 4.7 |
| Total amount | 100 | 100 | 100 |

Comparative Example 8 is composed within the claimed ranges for the components of the adhesives of the present invention and includes an increased amount of block copolymer resulting in a viscosity of more than 12,000 mPa·s at 190° C. application temperature, thus outside the useful parameters for the present invention.

Comparative Example 9 has a composition close to the embodiment examples of the present invention, but includes less than 35 wt.-% of ethylene/α-olefin interpolymer. Comparative Example 10 is a standard, commercially available APAO based hot melt adhesive composition.

With the adhesives of Examples mentioned above, performance testing has been used to evaluate the different adhesive compositions for the intended use of bonding packs of bottles. The testing involved exposing bottles hand bonded together with the adhesives of the invention to refrigeration to a temperature of 5° C., then heating to a temperature of 33° C. and then stress testing. Stress testing involved tilting over a six-pack up to five times alternately to the right and left on a wooden plate until at least one bottle was released. If a six-pack survived this stress test, it would be lightly hit against a pillar or wall to simulate the consumer e.g. accidentally hitting a car's trunk. As a final stress test a six-pack would be dropped to the ground (wooden plate) from a height of approx. 30-50 cm. The results were evaluated and graded as shown below:

Test Procedure

1. Step: 5 times—tilting over the six-pack

2. Step: 3 times—hit the six-pack lightly against a wall

3. Step: 3 times—drop the six-pack down to the floor from approx. 30-50 cm

Evaluation:
Grade 1: the six-pack passed all testing steps and bottles showed strong bonding; difficult to remove bottles from the six-pack
Grade 2: the six pack passed all testing steps, but some adhesive joints have failed
Grade 3: the six pack passed testing steps 1 and 2
Grade 4: the six pack passed testing step 1
Grade 5: the six pack was destroyed after less than 5 times of tilting
Grade 6: the six pack was destroyed during storage or first lifting

Grades 1 to 3 are generally acceptable for most applications of the adhesive compositions.

Properties of the Example compositions and their performance is summarized below in Table 3.

TABLE 4
Properties and test results

| | | | | | Comp. | Comp. | Cornp. |
|---|---|---|---|---|---|---|---|
| | Ex. 1 | Ex. 2 | Ex. 3 | Ex. 7 | Ex. 8 | Ex. 9 | Ex. 10 |
| viscosity | | 9000 | 9650 | 9000 | 12300 | | |
| @ 190° C. | | | | | | | |
| [mPas]: | | | | | | | |
| Ring & | | 96° C. | 95° C. | 100° C. | | | |
| Ball | | | | | | | |
| [° C.]: | | | | | | | |
| Test | | | | | | | |
| results: | | | | | | | |
| 1 day @ | 3 | 2-3 | 2 | 1 | 3 | 5 | 2 |
| 5° C. | | | | | | | |
| 1 day @ | — | 1 | 1 | 1 | 1 | A/C | 5 |
| 33° C. | | | | | | | |
| 4 days @ | — | 3 | 2-3 | — | 2-3 | A/C | — |
| 5° C. | | | | | | | |
| 4 days @ | — | 3 | 3 | — | 1 | — | — |
| 33° C. | | | | | | | |

A = adhesive failure
C = cohesive failure
— = not tested

The results of Table 4 show for the embodiment example compositions overall good adhesive properties for bonding bottle six-packs. Comparative Example 8 has shown a worse machinability due to too high application temperature viscosity. Comparative Examples 9 and 10 clearly demonstrate the non-suitability of compositions outside the claimed range and without using ethylene/α-olefin interpolymers. From the embodiment examples, while Example 2, although good at ambient to higher temperatures, is less good for cold temperature performance, Example 3 shows the superiority in cold adhesion properties of compositions using tackifying resins having lower softening points. Example 7 shows additional improvements in using grafted ethylene/α-olefin interpolymers.

The above specific examples are not intended to limit the present invention. Rather, other embodiments are within the appended claims.

1. A hot melt adhesive composition, comprising:
a) from about 35 to about 60 weight percent of at least one homogenous linear or substantially linear interpolymer of ethylene and α-olefin;
b) from about 5 to about 25 weight percent of at least one block copolymer;
c) from about 25 to about 45 weight percent of at least one tackifying resin; and
d) less than 10 weight percent of at least one wax;
wherein the sum of components a), b) and c) amounts to at least 85 weight percent of the total adhesive composition, and
wherein the composition has a Brookfield viscosity at a temperature of 190° C. in the range from about 7,000 to about 12,000 mPa·s.

2. The hot melt adhesive composition of claim 1, wherein the at least one homogenous linear or substantially linear interpolymer of ethylene and α-olefin is grafted with a dicarboxylic acid anhydride.

3. The hot melt adhesive composition of claim 1, wherein the at least one homogenous linear or substantially linear interpolymer of ethylene and α-olefin has a melt flow index in the range of about 300 to about 1,500 g/10 min.

4. The hot melt adhesive composition of claim 1, wherein the at least one homogenous linear or substantially linear interpolymer of ethylene and α-olefin has a density of from about 0.860 to about 0.890 g/cm³.

5. The hot melt adhesive composition of claim 1, comprising a mixture of at least two different homogenous linear or substantially linear interpolymers of ethylene and α-olefin.

6. The hot melt adhesive composition of claim 1 comprising from about 40 to about 50 weight percent of the at least one homogenous linear or substantially linear interpolymer of ethylene and α-olefin.

7. The hot melt adhesive composition of claim 1, wherein the α-olefin is 1-octene.

8. The hot melt adhesive composition of claim 1, wherein the at least one block copolymer is selected from a group consisting of styrene-ethylene/butylene-styrene (SEBS) and styrene-ethylene/propylene-styrene (SEPS).

9. The hot melt adhesive composition of claim 1, comprising from about 10 to about 15 weight percent of the at least one block copolymer.

10. The hot melt adhesive composition of claim 1, wherein the at least one tackifying resin has a Ring & Ball softening point of about 90° C. or less.

11. The hot melt adhesive composition of claim 1, including a mixture of at least two resins having different Ring & Ball softening points.

12. The hot melt adhesive composition of claim 1, wherein the at least one tackifying resin is selected from cycloaliphatic hydrocarbon compounds.

13. The hot melt adhesive composition of claim 1, wherein the sum of components a), b) and c) amounts to at least 90 weight percent of the total adhesive composition.

14. The hot melt adhesive composition of claim 1, wherein the at least one wax is selected from the group consisting of paraffin waxes, microcrystalline waxes, Fischer-Tropsch waxes, synthetic high melting point waxes (HMP) and hydrogenated microwaxes.

15. The hot melt adhesive composition of claim 1, wherein the composition is free of plasticizer.

16. A hot melt adhesive composition, consisting of:
a) from about 35 to about 60 weight percent of at least one homogenous linear or substantially linear interpolymer of ethylene and 1-octene;
b) from about 5 to about 25 weight percent of at least one block copolymer;
c) from about 25 to about 45 weight percent of at least one tackifying resin; and
d) from about 1 to 10 weight percent of at least one wax; and
e) at least one antioxidant,
wherein the sum of all components amounts to 100 percent, and
wherein the composition has a Brookfield viscosity at a temperature of 190° C. in the range from about 7,000 to about 12,000 mPa·s.

17. A hot melt adhesive composition, consisting of:
a) from about 40 to about 50 weight percent of at least one homogenous linear or substantially linear interpolymer of ethylene and 1-octene;
b) from about 10 to about 15 weight percent of at least one block copolymer,
c) from about 30 to about 40 weight percent of at least one tackifying resin; and
d) from about 3 to about 6 weight percent of at least one wax; and
e) at least one antioxidant,
wherein the sum of all components amounts to 100 percent, and
wherein the composition has a Brookfield viscosity at a temperature of 190° C. in the range from about 7,000 to about 12,000 mPa·s.

18. The use of the hot melt adhesive composition of claim 1, for bonding bundles of containers such as bottles or cans into packs.

19. The use of claim 18, wherein the adhesive composition is applied directly onto the containers.

20. A container pack comprising a plurality of containers, wherein the containers are bonded to each other with an adhesive composition according to claim 1.
